(19) United States
(12) Patent Application Publication
(10) Pub. No.: US 2004/0077189 A1
(43) Pub. Date: Apr. 22, 2004

(54) Adhesive interconnector

(76) Inventors: Frank St. John, Rockford, IL (US); Albert Chiappetta, Elmhurst, IL (US)

Correspondence Address: BLANK ROME LLP, 600 NEW HAMPSHIRE AVENUE, N.W., WASHINGTON, DC, 20037, US

(21) Appl. No.: 10/271,790

(22) Filed: Oct. 17, 2002

(51) Int. Cl. H01R 12/00

(52) U.S. Cl. 439/60

(57) ABSTRACT

The present invention is to provide a flexible interconnector that contains a cable having an adhesive on one terminal end and a ZIF connector at the other terminal end. In a preferred embodiment, the cable is a flat ribbon cable. When used to connect two electrical subassemblies, one end of the connector is connected to connecting terminals on a first electrical subassembly via an adhesive, while the other end is connected to a second electrical subassembly via a ZIF connector.

### BACKGROUND OF THE INVENTION

1. Field of the Invention

The present invention relates. to electrical interconnetors. In particular, the interconnector comprises a cable that connects two electronic subassemblies, such as printed circuit boards (PCB), by an adhesive and a zero insertion force (ZIF) connector.

2. Background of the Invention

The literature is replete with novel and efforts to meet the challenge of making a low cost, reliable interconnection between electronic subassemblies such as printed circuit boards. However, the need remains for better interconnect solutions for a variety of applications.

The most common applications involve connectors for electrically bridging individual printed circuit boards (PCBs). Traditionally, the connection of closely-stacked parallel PCBs has been achieved with rigid connectors, such as those disclosed in U.S. Pat. Nos. 6,270,374; 6,319,066; and 6,296,496. These are typically made of two mating halves, a male and a female, each having leads to attach to the PCB and receptacles captured in a rigid housing. One advantage of rigid connectors is that the various halves of the connectors are easily surface mountable and some degree of automation can be employed when they are attached to the PCB. However, they often require manual processes to mate the two PCBs to each other, and they are susceptible to mechanical failure due to stress induced by tolerance stackup or by mechanical shock when dropped onto a surface. Some have sought to overcome these problems by creating a flexible interconnection between the two PCBs. This is typically achieved by plugging a flexible circuit into a connector which is mounted on the PCB. While this solves the stress problem in the assembly, a rigid connector still exists on each PCB and additional parts are required. In addition, flexible circuits do not lend themselves well to automated assembly. The following patents show exemplary flexible connectors of the prior art:

U.S. Pat. No. 5,299,089 to Lwee discloses a ribbon cable 46 that is soldered on one end to pins of a contact array 36 of a memory card 3. The other end of the ribbon cable 46 is connected to a ZIF connector 48 of the circuit board 44. There is no disclosure of connecting the ribbon cable via an adhesive.

U.S. Pat. No. 5,928,001 to Gillette et al. discloses a flexible interconnect 110 for connecting two electronic subassemblies 200 and 300. The first end 116 of the flexible interconnect 110 is attached to the first subassembly 200 via solder balls 123. The second end 124 of the flexible interconnect 110 is connected to the second subassembly 300 via a ZIF connector 310. There is no disclosure of connecting the flexible interconnect to either subassembly via an adhesive.

U.S. Pat. No. 6,172,620 to Brick et al. discloses a ribbon cable 92 for connecting a keypad 18 to a circuit board 100. The ribbon cable 92 has a ZIF connector 92 at each end for connecting to the keypad 18 and the circuit board 100. There is no disclosure of connecting the ribbon cable to either the keypad or the circuit board via an adhesive.

U.S. Pat. No. 4,113,981 to Fujita et al. discloses an electrically conductive adhesive for connecting the connecting terminals 4a of a printed circuit 4 on a printing plate 1 to a flat cable 2. There is no disclosure of a ZIF connector.

Despite these prior art devices, a need still exists for a surface mountable flexible interconnect which is not limited to PCB-to-PCB interconnection applications. Furthermore, the need exists for a flexible interconnect which is amenable to manufacturing environments in which two subassemblies requiring interconnection do not share a common manufacturing line (i.e., where the two subassemblies are never situated side-by-side during manufacturing operations).

### SUMMARY OF THE INVENTION

An object of the present invention is to provide a flexible interconnector comprising a cable. The cable has an adhesive on one terminal end and a ZIF connector at the other terminal end. In a preferred embodiment, the cable is a flat ribbon cable. When used to connect two electrical subassemblies, one end of the connector is connected to connecting terminals on a first electrical subassembly via an adhesive, while the other end is connected to a second electrical subassembly via a ZIF connector.

Another object of the present invention is to provide a method of interconnecting two electrical subassemblies, such as PCBs. The method comprising providing a cable, connecting a terminal end of the cable to a first electrical subassembly using an adhesive, and connecting the other terminal end of the cable to a second electrical subassembly via a ZIF connector.

### BRIEF DESCRIPTION OF THE DRAWINGS

The foregoing background and summary, as well as the following detailed description of the invention, will be better understood when read in conjunction with the appended drawings. For the purpose of illustrating the invention, there is shown in the drawings embodiments which are presently preferred. It should be understood, however, that the invention is not limited to the precise arrangements and instrumentalities shown. In the drawings:

FIG. 1 shows a side view of the flexible interconnector connecting two electrical subassemblies.

FIG. 2 shows a top view of the flexible ribbon interconnector connecting two electrical subassemblies.

FIG. 3 shows a top view of the flexible ribbon interconnector.

FIG. 4 shows the detailed composition of the adhesive connecting the cable to the electrical assembly (not drawn to scale).

FIG. 5 shows the electrical assembly prepared to accept the ZIF connector.

FIG. 6 shows the ZIF connector attached to the electrical assembly.

### DETAILED DESCRIPTION OF THE PREFERRED EMBODIMENTS

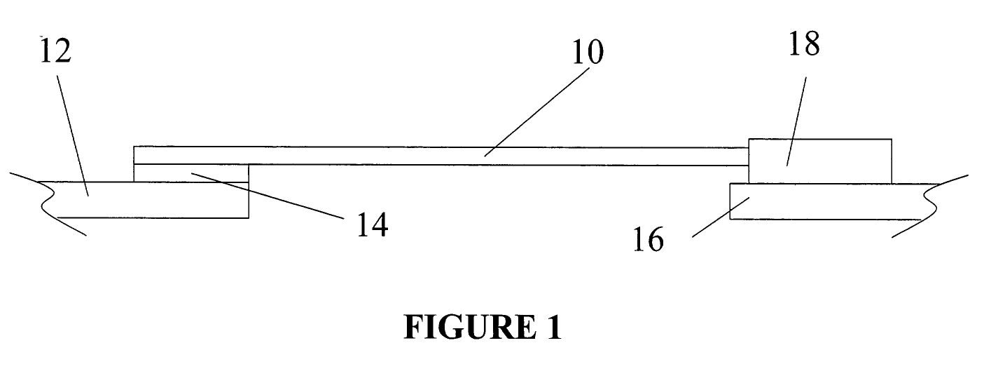

FIG. 1 shows a typical use of the interconnector of the present invention. Two electrical subassemblies (12, 16) are connected by a cable (10). One terminal end of the cable (10) is connected to a first electrical subassembly (12) with an adhesive (14). The other terminal end of the cable (10) is connected to a second electrical subassembly (16) with a ZIF connector (18).

The electronic subassembly is usually a PCB, but can also be, memory cards, computer components, PC card applications, liquid crystal diode (LCD) displays, security devices, personal digital assistants (PDA), digitization of analog information scanners, internet connections. Other wireless communication applications can also be appropriately used with the connector.

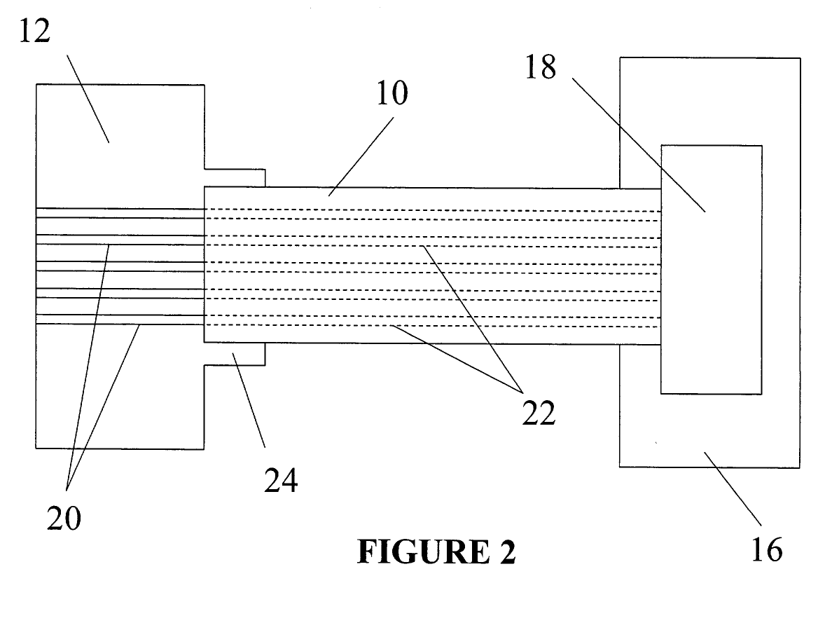

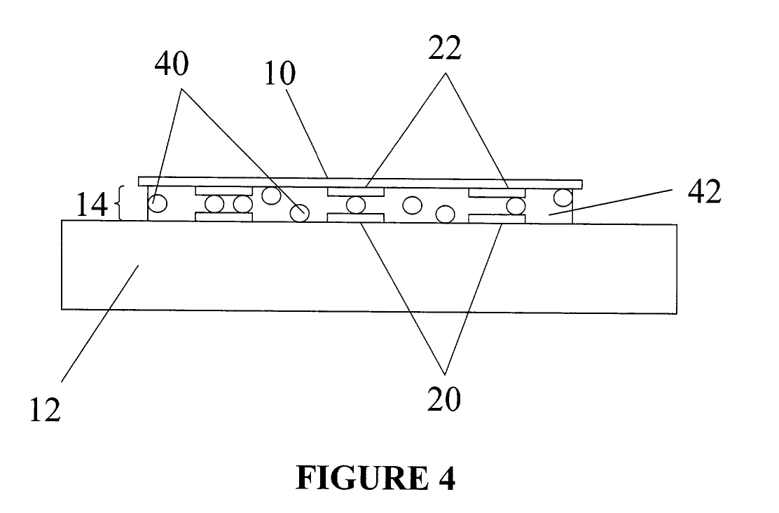

Referring to FIG. 2, the portion of the electronic subassembly (12) that attaches to the cable with an adhesive is formed as a junction (24) where an array of connecting terminals (20) is disposed on the PCB. When the insulation is stripped from a terminal end of the cable, an array of conductors are available and corresponds to the connecting terminals on the PCB. The conductors (22) of the cable and the connecting terminals (20) of the PCB are placed in electrical contact facing each other and are attached using an adhesive (see FIG. 4). It is preferable that only the insulation the side of the cable facing the PCB is stripped in order to maintain the conductors (22) in an ordered array.

The adhesive used is preferably a conductive adhesive as disclosed in U.S. Pat. No. 4,113,981, the disclosure of which is incorporated herein by reference. Referring to FIG. 4, the adhesive (14) comprises a non-conductive base material (42) and electrically conductive particles (40) incorporated in the non-conductive base. When the adhesive is disposed between facing electrodes, the conductive particles (40) provide electric conductivity between facing electrodes, while the non-conductive base material (42) maintains electric insulation in the lateral direction to prevent electrical contact between adjacent conductors. This is accomplished by having the electrically conductive particles (40) occupy less than about 60 percent by volume. At this concentration, the conductive particles are not generally in contact, and therefore, do not conduct electricity between the adjacent conductors which is illustrated in FIG. 4. When the corresponding conductors (22) and connecting terminals (20) are attached using the conductive adhesive, electrical continuity is created between the corresponding conductors (22) and connecting terminals (20) by the monolayer of electrically conductive particles (40) bridging the conductors (22) and connecting terminals (20) (see FIG. 4). However, because the density of the electrically conductive particles (40) is less than 60 percent by volume, the electrically conductive particles (40) are not generally in contact, thus, maintaining lateral insulation and preventing electrical contact between adjacent conductors (22) and adjacent connecting terminals (20).

Other adhesives, such as those disclosed in U.S. Pat. No. 3,334,040 to Conrad et al. and U.S. Pat. No. 3,359,145 to Salyer et al., the disclosures of which are incorporated herein by reference, are also appropriate for the present invention.

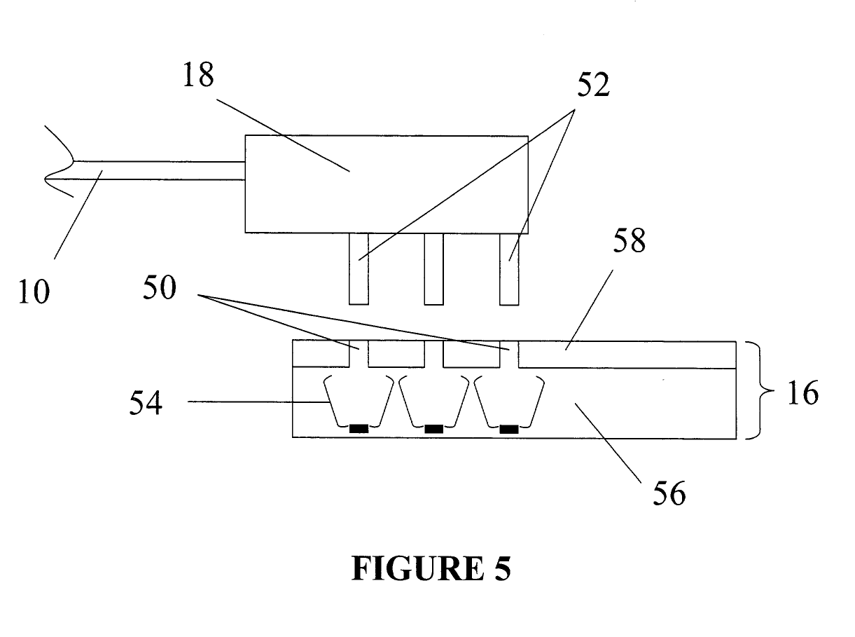

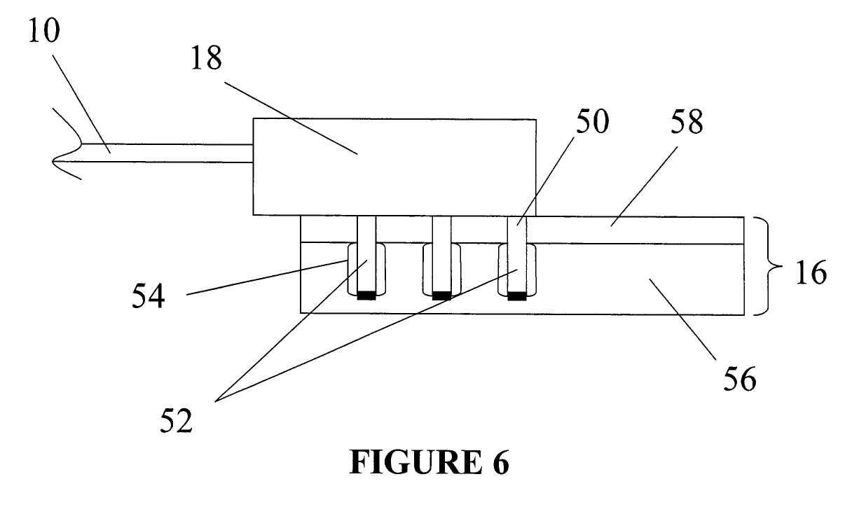

The ZIF connector (18) used in the present invention can be any ZIF connector presently known or later developed. Referring to FIGS. 5 and 6, the ZIF connector (18) generally has an array of pin legs (52) that are inserted into ZIF sockets (50) on the electrical subassembly (16). The socket generally comprises a base member (56) including an array of contacting terminals (54), and a cover member (58) defining an array of through holes (50) corresponding to the contacting terminals (54). A cam action is used to displace the contact terminals (54). When a lever (not shown) is moved to a first position, it moves a cam (not shown) which opens up the space into which pin legs (52) can be inserted into sockets (50) with zero insertion force (FIG. 5). After insertion, the lever is moved to a second position which clamps the contact terminals (54) to the pin legs (52) (FIG. 6).

In an alternative design, the cover member (58) is movable with respect to the base member (56). An end of each contacting terminal is soldered into a mounting hole of the electrical subassembly. The ZIF socket also includes actuation means (not shown) for selectively displacing the cover member between a first position and a second position. When the cover member is at the first position, pin legs of the ZIF connector are easily inserted into the corresponding holes, i.e. zero-insertion-force. When the actuating means is actuated, the cover member is moved to the second position thereby electrically connecting each pin of the ZIF connector with the corresponding contacting terminal. Various ZIF connectors, such as those of U.S. Pat. Nos. 6,280,223 to Lin; 6,254,415 to Mizumura et al.; 5,489,218 to McHugh; 5,454,727 to Hsu; 5,443,591 to Tsai; 4,630,874 to Renn et al.; 4,477,137 to Ayer; 4,252,392 to Whiteman, Jr.; 4,270,826 to Narozny; and 3,569,905 to Kehagiolou, the disclosures of which are incorporated herein by reference, are appropriate for the present invention.

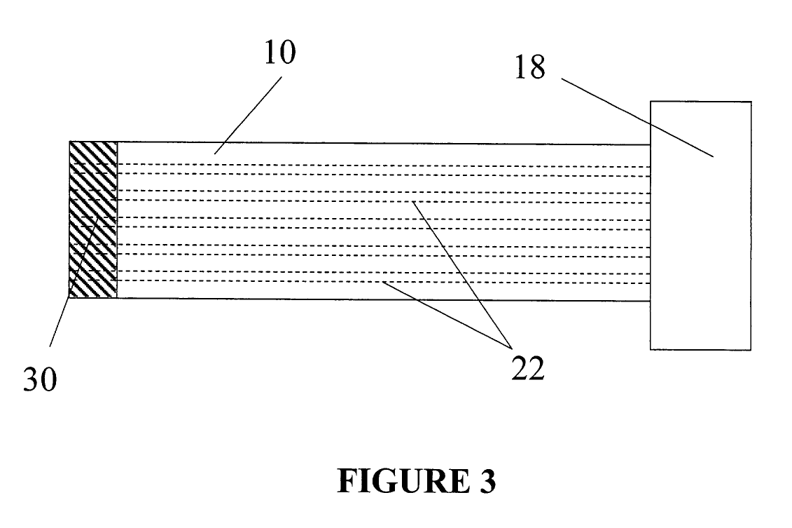

The cable (10) of the present invention is preferably a flexible ribbon cable which is shown in FIGS. 2 and 3. The flexible ribbon cable generally comprises conductors (22), usually formed of wires, inserted or laminated between two adhesive films. The adhesive film consists of a resin film and an adhesive layer on the surface so that the conductors are adhered to the resin film via the adhesive layers. Alternatively, the films can be bonded together by ultrasonic bonding where no adhesive is required. In either cases, the conductors are insulated from each other. In the first case, the adhesive fills between the adjacent conductors to provide insulation; and in the second case, the bonding of the films between the adjacent conductors provides the insulation. A suitable flexible ribbon cable is disclosed in U.S. Pat. No. 6,316,104 to Kamarura, the disclosure of which is incorporated herein by reference.

In a preferred embodiment, the interconnector is fabricated prior to connecting with the electrical subassemblies. This embodiment is shown in FIG. 3 in which the adhesive (30) is pre-deposited at one terminal end of the cable (10). The adhesive can be deposited as a tape. In this embodiment, the non-conductive base of the adhesive employs a material which is electrically insulating and is molten under heating, for example, a hot melt adhesive or a thermoplastic resin. Such materials can be, but are not limited to, polyethylene terephthalate (Mylar), polyethylene fluoride (Teflon), acrylic resins, and polyamide (nylon). Upon connecting with an electronic subassembly, the adhesive is heated to a molten state, compressed upon the electronic subassembly, and when the non-conducting base solidifies, connection of the interconnector and the electronic subassembly is accomplished. Bonding is thus achieved between the facing conductors (22) of the cable and the connecting terminals (20) of the electronic subassembly.

In a preferred embodiment, the interconnector of the present invention is used to electrically connect a LCD having exposed indium tin oxide (ITO) glass coated electrodes with a PCB. The glass coated electrode are connected to one terminal end of the cable with an adhesive; and a ZIF connector is located at the other terminal end of the cable ready to connect the LCD with the PCB.

Although certain presently preferred embodiments of the invention have been specifically described herein, it will be apparent to those skilled in the art to which the invention pertains that variations and modifications of the various embodiments shown and described herein may be made without departing from the spirit and scope of the invention. Accordingly, it is intended that the invention be limited only to the extent required by the appended claims and the applicable rules of law

What is claimed is:

1. An electrical assembly comprising:
a first electronic subassembly;
a second electronic subassembly; and
a cable connecting said first electronic subassembly to said second electronic subassembly, wherein said cable is connected to said first electronic subassembly by an adhesive and to said second electronic subassembly by a zero insertion force (ZIF) connector.

2. The electronic assembly of claim 1, wherein said cable is a ribbon cable.

3. The electronic assembly of claim 1, wherein the adhesive is conductive.

4. The electronic assembly of claim 1, wherein said first electronic subassembly is a liquid crystal display (LCD).

5. The electronic assembly of claim 1, wherein said first electronic subassembly comprising exposed indium tin oxide (ITO) glass coated electrodes.

6. The electronic assembly of claim 5, wherein said cable attaching to said ITO glass coated electrodes.

7. The electronic assembly of claim 1, wherein the adhesive comprises a nonconductive base and electrical conductive particles.

8. The electronic assembly of claim 7, wherein the concentration of electrical conductive particles is less than 60 percent by volume.

9. A method of connecting two electronic subassemblies comprising:
providing a cable;
connecting a first end of said cable to a first electronic subassembly with an adhesive; and
connecting a second end of said cable to a second electronic subassembly with a ZIF connector.

10. The method of claim 9, wherein said cable is a ribbon cable.

11. The method of claim 9, wherein the adhesive is conductive.

12. The method of claim 9, wherein said first electronic subassembly is a liquid crystal display (LCD).

13. The method of claim 9, wherein said first electronic subassembly comprising exposed indium tin oxide (ITO) glass coated electrodes.

14. The method of claim 13, wherein said cable is attached to said ITO glass coated electrodes.

15. The method of claim 9, wherein the adhesive comprises a nonconductive base and electrical conductive particles.

16. The method of claim 15, wherein the concentration of electrical conductive particles is less than 60 percent by volume.

17. An electrical connector comprising a cable having a first end connecting to a ZIF connector and a second end having an adhesive tape.

18. The electrical connector of claim 17, wherein said cable is a ribbon cable.

19. The electrical connector of claim 17, wherein the adhesive is conductive.

20. The method of claim 17, wherein the adhesive comprises a nonconductive base and electrical conductive particles.

21. The method of claim 20, wherein the concentration of electrical conductive particles is less than 60 percent by volume.
